(19) United States
(12) Patent Application Publication
(10) Pub. No.: US 2025/0368326 A1
(43) Pub. Date: Dec. 4, 2025

(54) AIRCRAFT COMPONENT LONGEVITY

(71) Applicant: Archer Aviation Inc., San Jose, CA (US)

(72) Inventors: Benjamin TIGNER, Laguna Beach, CA (US); James Orbon, Newport Beach, CA (US)

(73) Assignee: Archer Aviation Inc., San Jose, CA (US)

(21) Appl. No.: 19/254,793

(22) Filed: Jun. 30, 2025

Related U.S. Application Data
(63) Continuation of application No. 18/018,116, filed on Jan. 26, 2023, now Pat. No. 12,377,975.
(60) Provisional application No. 63/057,613, filed on Jul. 28, 2020.

(51) Int. Cl. B64C 29/00; B64C 11/44; B64D 27/24; B64D 27/31; B64D 27/34; B64D 31/06; B64D 31/16; B64D 45/00

(52) U.S. Cl. CPC B64C 29/0033; B64C 11/44; B64D 27/24; B64D 27/31; B64D 27/34; B64D 31/06; B64D 31/16; B64D 2045/0085

(57) ABSTRACT

In an embodiment, proprotor pitch ranges used during nominal cruise flight may be varied. By selecting ideal combinations of proprotor pitch angle and proprotor rpm, instead of the proprotor blade pitch bearing spending most of its time in a first range, multiple ranges may be alternated between. Additionally, in an aircraft with multiple proprotors, the portion of total thrust produced by each individual proprotor may be varied over time in order to allow for proprotor blade pitch angle to be varied without varying proprotor rpm. By properly cycling between different blade pitch ranges, bearing life can be significantly increased.

### PRIORITY CLAIM

This application claims priority to U.S. provisional application having Ser. No. 63/057,613 (filed Jul. 28, 2020). These and all other extrinsic material discussed herein are incorporated by reference in their entirety. Where a definition or use of a term in an incorporated reference is inconsistent or contrary to the definition of that term provided herein, the definition of that term provided herein applies and the definition of that term in the reference does not apply.

### FIELD OF THE INVENTION

The field of the invention is VTOL aircraft component longevity.

### BACKGROUND

Metallic Ball bearings have known deficiencies when used for propeller or rotor blade feather axis bearings. Rotor or propeller blades often operate within a relatively small pitch angle envelope for most of their service life. The small range of angles for which the bearing operates results in dramatically shortened service life. Ball bearings are better suited for applications with consistent rotation and change in relative static position.

### SUMMARY

In an embodiment, proprotor pitch ranges used during nominal cruise flight may be varied. By selecting ideal combinations of proprotor pitch angle and proprotor rpm, instead of the proprotor blade pitch bearing spending most of its time in a first range, multiple ranges may be alternated between. Additionally, in an aircraft with multiple proprotors, the portion of total thrust produced by each individual proprotor may be varied over time to allow for proprotor blade pitch angle to be varied without varying proprotor rpm. By properly cycling between different blade pitch ranges, bearing life can be significantly increased.

### BRIEF DESCRIPTION OF THE DRAWINGS

FIG. 1 illustrates a quad tiltrotor aircraft on which an embodiment may be beneficially implemented.

FIG. 2 illustrates a proprotor hub assembly.

FIG. 3 illustrates a proprotor blade pitch bearing.

FIG. 4 illustrates a proprotor blade pitch bearing.

FIG. 5 illustrates a quad tiltrotor aircraft on which an embodiment may be beneficially implemented.

FIG. 6 illustrates a set of steps for increasing bearing life.

FIG. 7 illustrates a set of steps for increasing bearing life.

FIG. 8 illustrates a set of steps for increasing bearing life.

FIG. 9 illustrates an aircraft with coaxial proprotors on which embodiments described herein may be beneficially implemented.

FIG. 10 illustrates hardware used for implementing an embodiment described herein.

### DETAILED DESCRIPTION

During the service life of an aircraft, aircraft proprotor blades may spend a large portion of their service life within a small pitch range. A propeller or rotor blade may spend all or most of its service life within a twenty-degree angular window. During different periods of operation, the pitch angles may be concentrated within an even smaller rotational window—for extended periods of time. These type of load cycles will over time wear the bearing out due to fretting—often causing pitting of the bearing races. The bearings will wear much more rapidly than if the bearing rotated continuously.

Changing controllable variables to increase component longevity can be an efficient way of increasing the economics and reliability of an aircraft. Implementing control laws that use life cycle information of components can increase component life expectancy.

One solution—to extending the expected life of feather axis bearings—is to implement a system configured to vary propeller pitch throughout the service life of the bearing. Propeller rpm and propeller pitch (and thus propeller advance ratio) may be varied to increase the life of the propeller pitch blade bearings.

Traditionally, the first degree of freedom of a propeller system is used to trim the aircraft and then the final degrees of freedom are used to attain peak efficiency. However, some embodiments herein intentionally set the propeller blades to a given pitch, and use the remaining degrees of freedom—such as rpm—to trim the aircraft for the desired aircraft speed. In some embodiments, a certain rpm may be commanded and the then pitch used to trim the aircraft. If different rpm's are commanded for approximately the same thrust requirements, the resulting pitch setting of the rotor blade—and thus pitch bearing—will be varied over time. Some embodiments may schedule rpm and pitch change to change in sync. While there may be some efficiency loss—the efficiency losses can be outweighed by the longevity benefits.

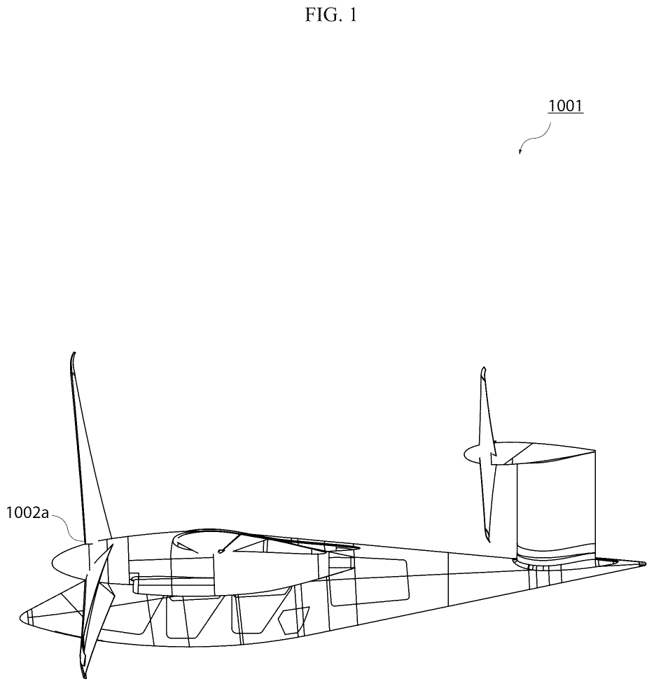

Shown in FIG. 1 is a quad tiltrotor aircraft 1001 that would be especially well suited for an implementation of aspects discussed herein. When the quad tiltrotor aircraft 1001 is in wingborne flight mode, a certain amount of drag is created by the aircraft—in order to maintain constant forward velocity. A certain amount of cumulative thrust is required to be generated by the confluence of propellers. Aircraft such as some of the aircraft discussed in U.S. Pat. No. 10,351,235B2 to Karem, incorporated hereby by reference in its entirety, and U.S. patent application Ser. No. 16/869,188 to Karem, incorporated hereby by reference in its entirety, may especially benefit from embodiments disclosed herein.

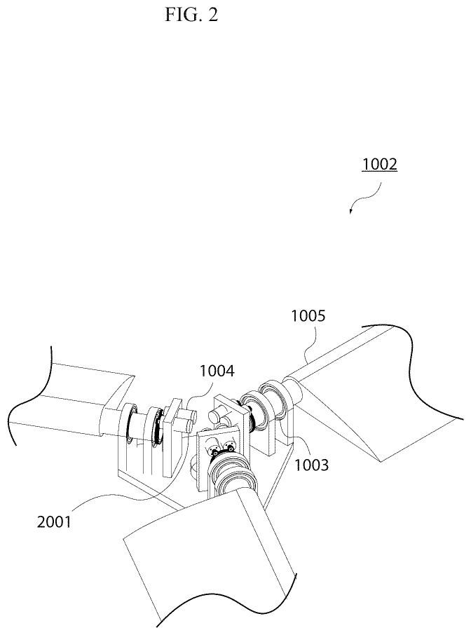

FIG. 2 shows a proprotor assembly 1002 comprising blade pitch bearings 1003, blade pitch actuators 1004 and proprotor blades 1005. The bearings are ideally metallic ball bearings. However, in some embodiments the bearing may be any suitable bearing, including: ceramic ball bearings, bushing type bearings, or roller bearings.

It should be understood the proprotor pitch actuators 1004 may comprise any suitable proprotor blade pitch actuator including linkage type actuation systems, geared actuator systems, rotary actuator systems, linear actuator systems, or any combination of the aforementioned systems. The proprotor blades may be any suitable type of proprotor blade including composite proprotor blades. Especially preferred embodiments use proprotor blades such as the blades described in U.S. Pat. No. 6,641,365 B2 to Karem, incorporated hereby in its entirety by reference.

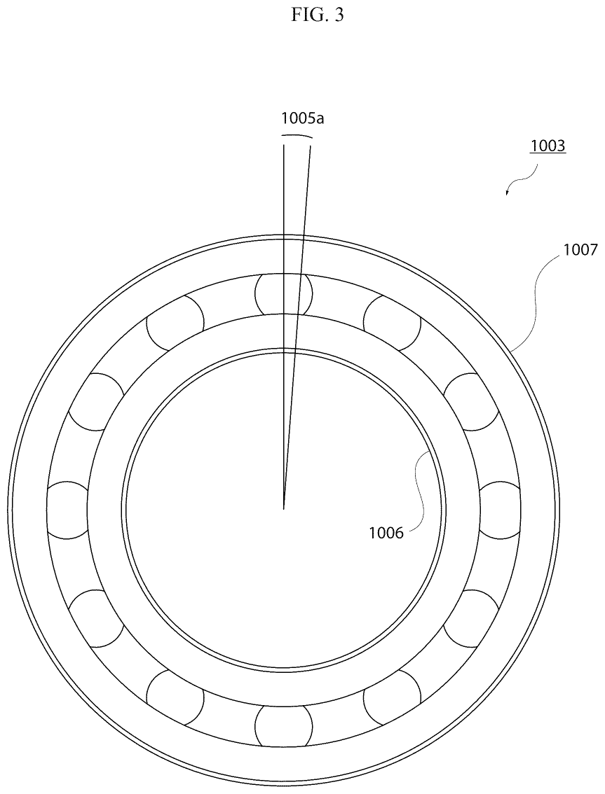

FIG. 3 shows blade pitch bearing 1003 and range 1005a which may represent the range of angles an inner bearing race 1006 of the bearing—and the attached proprotor blade assembly—may rotate through while maintaining nominal cruise flight. Blade pitch bearing 1003 comprises inner race 1006 and outer race 1007. Other bearing arrangements may be used. For example, some embodiments may use a feather axis bearing inside the proprotor root—in which case the outer race of the bearing would rotate with the proprotor blade.

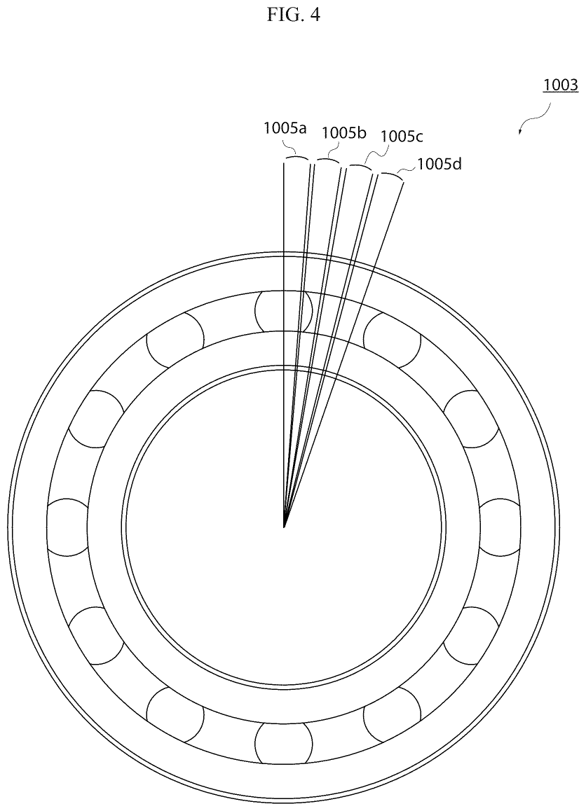

FIG. 4 shows multiple angular ranges 1005a, 1005b, 1005c, and 1005d through which the inner race—and the blade assembly fixed thereto—may rotate through. Angular range 1005a may correspond to a range of propeller pitch angles that a propeller would traditionally stay within while maintaining a certain forward cruise speed that is most ideal from a motor performance standpoint or from a propeller efficiency standpoint. By cycling through ranges 1005a, 1005b, 1005c, and 1005d, the life of bearing 1003 may be prolonged.

Any number of ranges may be used. Furthermore, some implementations may not use ranges at all, but rather expand the spectrum of angles through which a proprotor blade rotates during nominal cruise flight or other normal operating conditions.

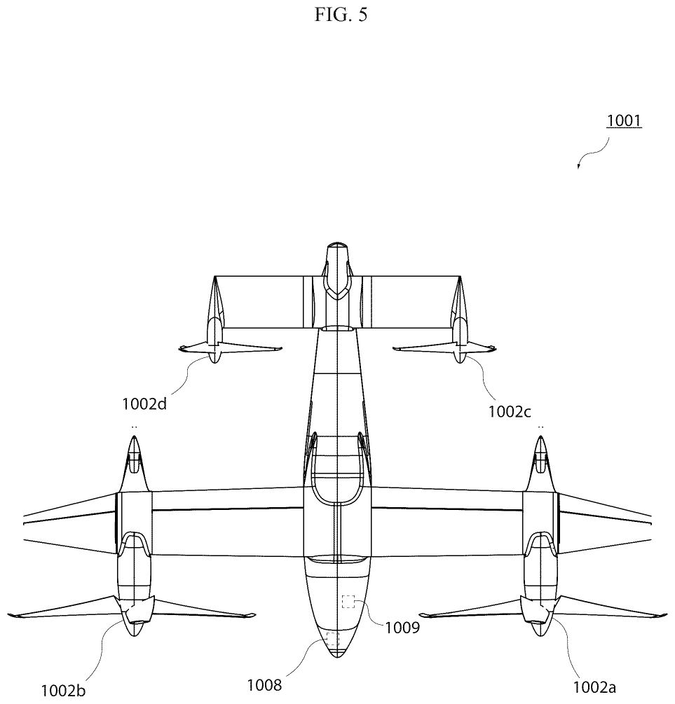

Shown in FIG. 5, aircraft 1001 may comprise an aircraft control system 1009 configured to command a net thrust from aircraft proprotor assembly 1002. There may be any number of aircraft proprotor assemblies 1002, but especially preferred embodiments will comprise 4 proprotor systems. Aircraft 1002 further comprises electronic flight control system 1008.

In one embodiment aircraft control system 1009 commands a first thrust from electronic flight control system 1008. The thrust command may have an associated thrust vector, for example directly forward. Electronic flight control system 1008 may command the first amount of thrust from the proprotors 1002 with a first combination of thrust and proprotor revolutions per minute (rpm).

Returning to FIG. 4, the proprotor pitch ranges used during nominal cruise flight may be varied. By selecting ideal combinations of proprotor pitch angle and proprotor rpm, the time a bearing spends in one pitch range can be varied. For example, instead of the proprotor bearing spending most of its time in range 1004a, ranges 1004b, 1004c, and 1004d may alternated between. Rotating amongst different pitch ranges can significantly extend the bearing life.

A given proprotor will have certain efficiency vs. advance ratio characteristics. For many proprotors—operating in propeller mode—there can be a fairly wide range of proprotor pitch angles which result in approximately equivalent efficiencies. Electronic flight control system 1008 may be configured to command combinations of pitch and rpm that result in optimal efficiency. In general, as the commanded pitch setting increases, the commanded rpm—and thus advance ratio—will increase as well to achieve the highest attainable efficiency at different pitch settings—for a given aircraft speed. For example, if a pitch of fifteen degrees is commanded, electronic flight control system 1008 will command a corresponding rpm that results in a certain advance ratio. If electronic flight control system 1008 commands a second pitch of 20 degrees, the corresponding commanded advance ratio—resulting from the commanded rpm—will increase.

There are several combinations of pitch settings and advance ratio settings that result in acceptable efficiency penalties relative to the peak efficiency of the proprotor. When a pitch is commanded, a corresponding advance ratio is selected and commanded as well—by way of commanding a certain rpm. As the thrust may be affected by proprotor rpm and pitch setting, the electronic flight control system 1008 needs to select a combination of advance ratio and pitch setting that results in the commanded thrust.

In some embodiments, the aircraft control system 1009 may determine that optimal efficiency and component longevity is provided by periodically varying the speed of the aircraft. Optimal efficiency for a commanded proprotor pitch angle may result from slightly varying the amount of thrust which will inevitably lead to a change in aircraft velocity.

In one embodiment—such as the one shown in FIG. 2—rotor 1002 may comprise a sensor 2001 which may comprise a resolver, an encoder, or another known type of feedback sensor. The sensor 2001 sends a signal to the electronic flight control system, which may then use the signal to compute bearing history data. Alternatively, the back emf of the actuators may be used to generate a signal—the signal can then be used to calculate bearing history data. In some embodiments, information from sources such as bench tests may be referenced by the electronic flight control system.

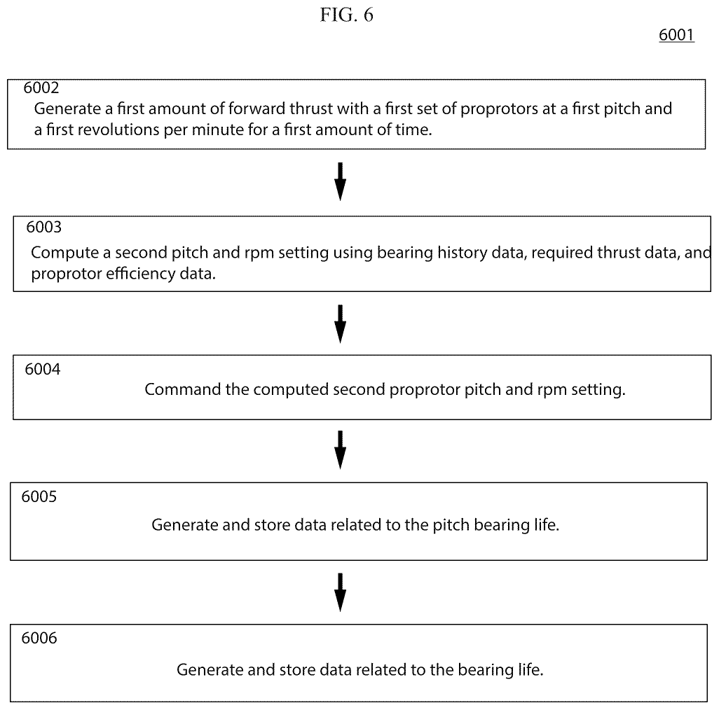

Electronic flight control system 1008 may be configured to carry out the steps of FIG. 6. The electronic flight control system 1008 may command the motors and proprotors to generate a first amount of forward thrust with a first set of proprotors at a first pitch and a first rpm for a first amount of time. The electronic flight control system 1008 may compute a second pitch and rpm setting using bearing history data, required thrust data and proprotor efficiency data. Using the computed second pitch and rpm setting, the electronic flight control system may command the computed second proprotor pitch and rpm setting of the proprotor and powertrain. The electronic flight control system 1008 may cause bearing history data to be generated and stored.

Bearing history data may comprise any data relevant to bearing wear including: the time one or more rotor blades—and thus the corresponding blade pitch bearing or bearings—have spent within a particular angular range—either in an immediately preceding time window or over a certain amount of past time; loads acting upon one or more rotor blades; the number of pitch change cycles a rotor blade—and thus the corresponding bearing(s) has undergone; the angular range of blade pitch over a given time; the number of small magnitude pitch change cycles corresponding to specific angular regions of the overall blade pitch travel window; or a variable that serves as a proxy for bearing wear.

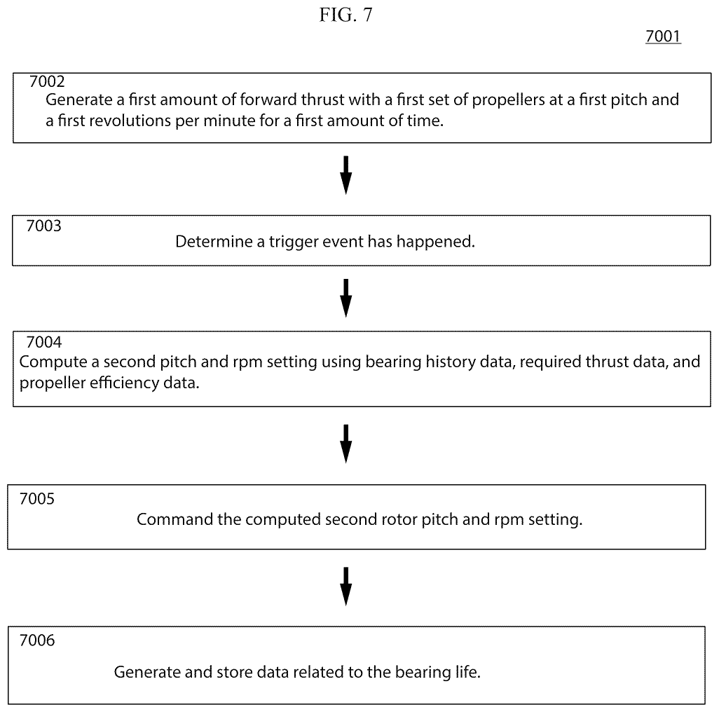

Electronic flight control system 1008 may be configured to implement the steps of FIG. 7. Electronic flight control system 1008 commands a first pitch and rpm from proprotors 1002 for a first amount of time. Electronic flight control system 1008 may then command a second pitch and rpm from proprotors 1002 which result in the same amount of thrust from each proprotor 1002. Electronic flight control system 1008 may generate and store data related to bearing life. The data may include information such as: the amount of time the bearing has spent within various pitch ranges 1005; the number of times the bearing 1003 has spent a prolonged amount of time at specific pitch angles; and loads sustained while the bearing was within particular pitch ranges.

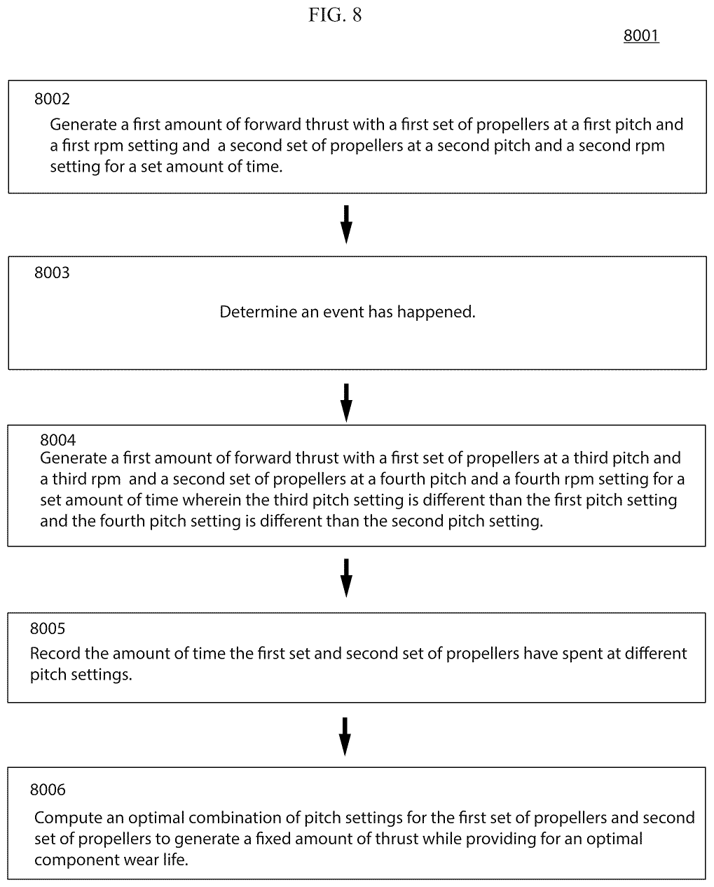

Electronic flight control system 1008 may be configured to implement the steps of FIG. 8. The electronic flight control system 1008 may generate a commanded thrust with a first set of propellers at a first rpm and pitch setting and a second set of propellers at a second pitch and a second rpm setting for a set amount of time.

For example, aircraft 1001 may generate 45% of thrust using the front pair of proprotors and 55% percent of the thrust using the rear pair of proprotors. The front pair of proprotors will have a commanded rpm and pitch setting. Likewise, the rear proprotors will have a commanded rpm and pitch setting.

The electronic pitch control system 1008 may then implement step 8003 of determining an event has happened. The event may comprise the passing of a certain amount of time that a proprotor blade has operated in a first range—for example, two minutes.

Executing step 8004, the electronic pitch control system generates the commanded amount of thrust using a second combination of thrust from the sets of proprotors. For example, the front pair of proprotors of aircraft 1001 may use a third pitch and advance ratio setting to generate a commanded thrust. And the rear pair of proprotors of aircraft 1001 may use a fourth advance ratio and pitch combination to generate a commanded thrust. For example, aircraft may generate 55% of the aircraft's required thrust using the front pair of proprotors and 45% of required thrust using the aft pair of proprotors.

Similar to the steps of flow chart 6001, the electronic pitch control system may store or cause to be stored information regarding lifetime pitch setting and other wear related information regarding the proprotor blade pitch bearings.

One benefit of the method discussed in FIG. 8 is to blend the thrust over multiple rotors in a varied manner. In doing so, the blade pitch setting for each specific rotor is averaged over a larger contact patch, and thus wear is not localized at a very specific pitch setting. Likewise, the methods of FIGS. 6 and 7 result in larger averaged contact patches for the blade pitch angle setting-thus reducing localized wear.

The electronic flight control system 1008 may use the information to compute optimal proprotor blade pitch, advance ratio, thrust distribution, and even aircraft speed to achieve the optimal combination of bearing life, propeller efficiency, and aircraft performance.

The method of 6001 is preferred to the method of 8001 for many applications because by increasing the thrust required from one set of propellers above what would normally be required, the bearing life will be shortened. However, in some applications the bearing life advantage gained from varying the pitch of the proprotors will be greater than the bearing life penalty resulting from increasing the proprotor load above nominal.

On the other hand, the method of 8001 may have an advantage in some passenger aircraft implementations because it can be implemented without significantly varying the proprotor rpms—which may be bothersome for passengers.

A combination of methods 7001 and 8001 may also be best suited for some applications.

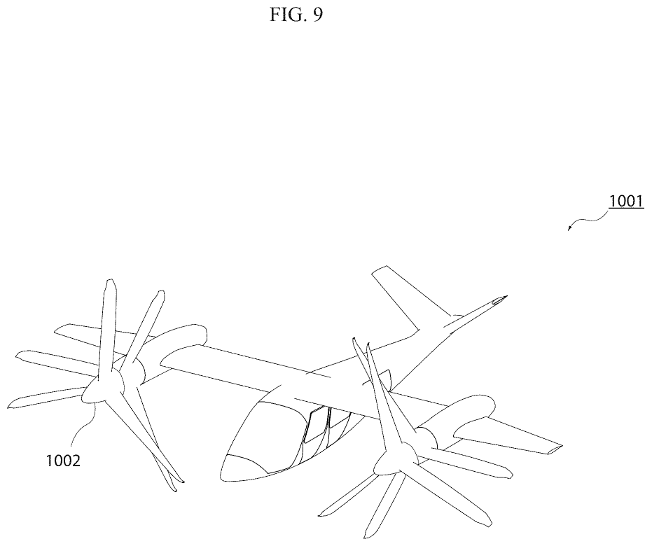

Coaxial quad tiltrotor aircraft such as the aircraft shown in FIG. 9 can benefit from concepts described herein. Some embodiments can redistribute thrust between the top and bottom rotor in each rotor stack to extend component life.

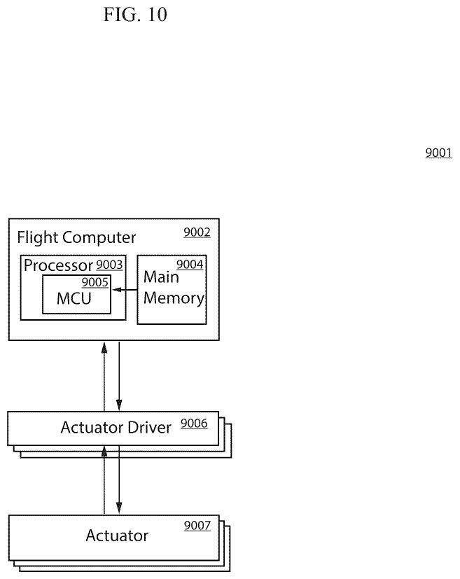

FIG. 10 illustrates one embodiment of hardware that can be used to implement concepts described herein. In the embodiment of FIG. 10, electronic flight control system 1008 comprises flight computer 9002. Flight computer 9002 comprises processor 9003 and main memory 9004. Processor 9003 comprises MCU 9005. Flight computer 9002 is in communication with actuator drivers 9006 which are each in communication with respective actuators 9007.

Especially preferred embodiments of the current invention are configured for electric vertical takeoff and landing (eVTOL) aircraft. Such aircraft may have motor characteristics especially well-suited for implementation of aspects discussed herein because of the wide constant power spectrum of the motor and the ease of quick and precise rpm control. For some motors—especially non-electric motors—the efficiency of the motor at different rpm speeds should be taken into account when computing the ideal proprotor blade pitch and proprotor rpm to achieve the optimal balance of efficiency and component longevity. Furthermore, the speed and precision at which electric motor rpm can be changed is often quicker than equivalent fuel consuming engines.

Some embodiments may incorporate information from sensors including hub moment sensors and blade load sensors, vibration sensors, blade pitch moment sensors. Such information may be used by the electronic flight control system 1008.

Proprotor systems—especially optimal speed rotors—with individual blade control may be particularly well suited for implementation of embodiments of concepts discussed herein.

It should be understood that principles described herein may apply equally to propellers, proprotors, or rotors operating in VTOL flight as well as propellers operating in horizontal flight mode. While specific examples herein describe tiltrotor aircraft, it should be understood that the principles may apply equally to any aircraft-including helicopters and propeller airplanes.

It should be noted that any language directed to an electronic flight control system or aircraft control system should be read to include any suitable combination of computing devices, including servers, interfaces, systems, databases, agents, peers, engines, controllers, or other types of computing devices operating individually or collectively. The computing devices may comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed above with respect to the disclosed apparatus. In some embodiments, various servers, systems, databases, or interfaces may exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network. Furthermore, the aircraft controller may include any suitable combination of computing devices, including servers, interfaces, systems, databases, agents, peers, engines, controllers, or other types of computing devices operating individually or collectively.

Aspects of the electronic flight control system may be located somewhere on the aircraft on which the proprotor is located or anywhere else including in a ground-based control center, on other aircraft, or even in components of the proprotor itself. Furthermore, in some embodiments the aircraft controller and the electronic flight control system and the aircraft control system may be implemented in distinguishable units or may be combined in one unit.

Any reference to a range of values should be understood to include each individual value within that range.

The aircraft control system may include inputs for human pilots to control various aircraft dynamics.

It should be recognized that concepts taught herein can equally apply to propellers, rotors or proprotors whether used in a helicopter, airplane, or tiltrotor aircraft. The term proprotor should be understood to encompass rotor, propeller, and proprotor. Additionally, rotor blade should be understood to encompass rotor blade, propeller blade, and proprotor blade.

1-25. (canceled)

26. An aircraft comprising:
a wing;
a blade;
a blade pitch actuator; and
a control system configured to:
compute, using bearing history data, a first pitch of the blade; and
command the blade pitch actuator to move the blade to the computed first pitch.

27. The aircraft of claim 26, wherein the bearing history data comprises time data of an amount of time the blade has spent in a pitch angle range.

28. The aircraft of claim 26, wherein the control system is further configured to:
compute, using a second bearing history data, a second pitch that is different from the computed first pitch;
command the blade pitch actuator to move the blade to the second pitch;
command a same amount of thrust when the blade is at the second pitch as when the blade is at the computed first pitch.

29. The aircraft of claim 28, wherein, to command the same amount of thrust, the control system is further configured to adjust revolutions per minute (RPM) of the blade.

30. The aircraft of claim 28, wherein the control system is further configured to compute, based on propeller efficiency data, a value for revolutions per minute (RPM) of the blade that corresponds to the second pitch.

31. The aircraft of claim 30, wherein the propeller efficiency data comprises propeller efficiency as a function of advance ratio.

32. The aircraft of claim 26, wherein the aircraft is at least one of:
an electric vertical takeoff and landing aircraft or
a tiltrotor aircraft.

33. The aircraft of claim 26, wherein, to compute the first pitch, the control system is further configured to use a portion of the bearing history data that corresponds to wingborne cruise flight.

34. The aircraft of claim 26, further comprising:
a bearing system configured to allow adjustment of a pitch of the blade, wherein the bearing history data reflects a usage of the bearing system; and
wherein computing the first pitch comprises computing a pitch that adjusts a wear of the bearing system to distribute a wear of the bearing system.

35. The aircraft of claim 26, wherein, to compute the first pitch, the control system is further configured to receive a signal from a sensor configured to measure a pitch angle of the blade.

36. A method of reducing pitch axis bearing degradation in an aircraft comprising a wing, a blade, a blade pitch actuator, and a control system, the method comprising:
determining, using bearing history data, a first pitch of the blade; and
commanding the blade pitch actuator to move the blade to the determined first pitch.

37. The method of claim 36, wherein the bearing history data comprises time data of an amount of time the blade has spent in a pitch angle range.

38. The method of claim 36, further comprising:
compute, using a second bearing history data, a second pitch that is different from the computed first pitch;
commanding the blade pitch actuator to move the blade to the second pitch;
commanding a same amount of thrust when the blade is at the second pitch as when the blade is at the determined first pitch.

39. The method of claim 38, further comprising adjusting revolutions per minute (RPM) of the blade to command the same amount of thrust.

40. The method of claim 38, further comprising determining, based on propeller efficiency data, a value for revolutions per minute (RPM) of the blade that corresponds to the second pitch.

41. The air method craft of claim 40, wherein the propeller efficiency data comprises propeller efficiency as a function of advance ratio.

42. The method of claim 36, further comprising using a portion of the bearing history data that corresponds to wingborne cruise flight to compute the first pitch.

43. The method of claim 36, wherein:
the bearing history data reflects a history of usage of a bearing system used to adjust a pitch of the blade; and
determining the first pitch comprises computing a pitch that adjusts a wear of the bearing system to distribute a wear of the bearing system.

44. The method of claim 36, further comprising receiving a signal from a sensor to compute the first pitch, wherein the sensor is configured to measure a pitch angle of the blade.

45. A non-transitory computer-readable medium that stores a set of instructions for commanding a blade pitch of aircraft, the instructions comprising:
determining, using bearing history data, a first pitch of the blade; and
commanding the blade pitch actuator to move the blade to the determined first pitch.

46. An aircraft comprising:
a wing;
a blade;
a blade pitch actuator; and
a control system configured to:
compute, using bearing history data, a first pitch angle range of the blade; and
command the blade pitch actuator to move the blade within the first pitch angle range.
